(19) United States
(12) Patent Application Publication
(10) Pub. No.: US 2015/0081944 A1
(43) Pub. Date: Mar. 19, 2015

(54) USB MEMORY HAVING NON-INSERTION TYPE CONNECTOR AND GENDER CONNECTED THERETO

(71) Applicant: DAE HAN SPECIAL METAL IND CO., LTD., Incheon (KR)

(72) Inventor: Joon-Bum An, Bucheon-si (KR)

(21) Appl. No.: 14/391,239

(22) PCT Filed: Apr. 15, 2013
(86) PCT No.: PCT/KR2013/003136

§ 371 Date: Oct. 8, 2014

(30) Foreign Application Priority Data
Apr. 17, 2012 (KR) 10-2012-0039794

(51) Int. Cl. G06F 13/40

(52) U.S. Cl. CPC G06F 13/4068; G06F 13/4045
USPC 710/300; 710/313

(57) ABSTRACT

Provided is a universal serial bus (USB) memory including a non-insertion type connector that comes into non-insertion contact with a non-insertion type port of an electronic device using magnetism and enables data transmission/reception with the electronic device, wherein the non-insertion type connector includes: a magnetic coupling member that is formed on a contact surface of a body and comes into surface contact with a magnetic coupling member formed on a contact surface of the non-insertion type port using magnetism; and a contact terminal that is formed on the contact surface and comes into non-insertion contact with the contact terminal when the magnetic coupling members are coupled to each other using magnetism, thereby enabling reciprocal power supply and data transmission.

### TECHNICAL FIELD

The present invention relates to a universal serial bus (USB) memory, and more particularly, to a USB memory having a non-insertion type connector, in which the non-insertion type connector is configured at the USB memory and a non-insertion type port of an electronic device, such as a personal computer (PC), can come into non-insertion contact with the non-insertion type connector using magnetism.

The present invention also relates to a gender connected to the USB memory, in which a non-insertion type port is configured at one end of the gender so as to come into non-insertion contact with the non-insertion type connector using magnetism and a USB connector is configured at the other end of the gender so as to be inserted into a USB port of the electronic device and the USB memory having the non-insertion type connector can be electrically connected to the electronic device having the USB port.

### BACKGROUND ART

In general, a universal serial bus (USB) has been developed as an interface for solving inconveniences caused by low speed of an existing legacy port (serial, parallel, PS/2) and limited device connection. The USB has been widely used so that no legacy port but only a USB port is configured at an electronic device, such as a new personal computer (PC).

A USB type connector is configured at various external type peripheral devices used to be mechanically connected to a PC, a notebook or a laptop computer in a USB manner or in other similar manners, in particular, a memory unit. Thus, the USB type connector physically comes into insertion contact with the USB port.

However, in the above-described coupling method of the USB port and the USB connector, the USB port generally has a concave groove shape, and the USB connector generally has a convex protrusion shape. Thus, a physical contact state becomes loose as the USB port and the USB connector contact each other or are separated from each other repeatedly so that damage like a contact state of contact terminals becomes bad or the contact terminals are bent in a separation direction when the contact terminals are separated from each other, occurs.

In addition, when the USB port and the USB connector are coupled to each other in a reverse direction or an unreasonable force is applied to the USB port and the USB connector due to wrong usage, a printed circuit board (PCB) connected to the contact terminals may be damaged together with damage of the contact terminals. In this case, an economical loss in which the contact terminals and the PCB should be replaced, may occur.

### DETAILED DESCRIPTION OF THE INVENTION

### Technical Problem

The present invention provides a universal serial bus (USB) memory having a non-insertion type connector, in which the non-insertion type connector is configured at the USB memory and a non-insertion type port of an electronic device, such as a personal computer (PC), is capable of coming into non-insertion contact with the non-insertion type connector using magnetism.

The present invention also provides a gender connected to the USB memory, in which a non-insertion type port is configured at one end of the gender so as to come into non-insertion contact with the non-insertion type connector using magnetism and a USB connector is configured at the other end of the gender so as to be inserted into a USB port of the electronic device and the USB memory having the non-insertion type connector is capable of being electrically connected to the electronic device having the USB port.

### Technical Solution

According to an aspect of the present invention, there is provided a universal serial bus (USB) memory including a non-insertion type connector that comes into non-insertion contact with a non-insertion type port of an electronic device using magnetism and enables data transmission/reception with the electronic device, wherein the non-insertion type connector includes: a magnetic coupling member that is formed on a contact surface of a body and comes into surface contact with a magnetic coupling member formed on a contact surface of the non-insertion type port using magnetism; and a contact terminal that is formed on the contact surface and comes into non-insertion contact with the contact terminal of the non-insertion type port when the magnetic coupling members are coupled to each other using magnetism, thereby enabling reciprocal power supply and data transmission.

The non-insertion type connector may further include a guide that is formed on the contact surface and causes a guide of the non-insertion type port to be guided so that non-insertion contact of the contact terminals can be precisely performed when the magnetic coupling members are coupled to each other using magnetism.

The magnetic coupling member may be configured as one of a magnetic member and a magnetized member, and when the magnetic coupling member is a magnetic member, the magnetic coupling member may include at least one selected from the group consisting of a magnet, an electromagnet, and a permanent magnet, and when the magnetic coupling member is a magnetized member, the magnetic coupling member may include a metal or ferromagnetic substance that can be coupled to the magnetic member using magnetism.

The contact terminal may be configured as one of a planar terminal, of which an end has a planar or concave surface, and an elastic terminal, of which an end has elasticity of a spring provided inside the elastic terminal or only the end bends toward a printed circuit board (PCB) with elasticity, and the planar terminal may have a structure in which the planar terminal is recessed into an inner side of a through hole formed in the contact surface PS or corresponds to a plane of the through hole, and the elastic terminal may have a structure in which a part of the elastic terminal protrudes toward an outer side of the through hole formed in the contact surface.

The guide may be formed as one of an embossed guide that protrudes from the contact surface and an intagliated guide that is recessed into the contact surface.

When the magnetic coupling member is a magnet, the magnetic coupling member may be manufactured using at least one method selected from the group consisting of vertical monopole, two-pole and four-pole magnetizers using equipment called a ‘magnetizing yoke’.

According to another aspect of the present invention, there is provided a gender in a universal serial bus (USB) memory having a non-insertion type connector that is formed on a contact surface and includes a magnetic coupling member and a contact terminal, the gender including: a non-insertion type port that is formed at one side of a body and comes into electrical non-insertion contact with the non-insertion type connector using magnetism; and a USB connector that is formed at the other side of the body and is inserted into a USB port of the electronic device, wherein the non-insertion type port includes: a magnetic coupling member that is coupled to the magnetic coupling member using magnetism; and a contact terminal that comes into non-insertion contact with the contact terminal when the magnetic coupling members are coupled to each other using magnetism.

When the non-insertion type connector may include a guide formed on the contact surface, the non-insertion type connector may further include a guide that is formed on the contact surface and is guided by the guide so that non-insertion contact of the contact terminals can be precisely performed when the magnetic coupling members are coupled to each other using magnetism.

The magnetic coupling member may be configured as one of a magnetic member and a magnetized member, and when the magnetic coupling member is a magnetic member, the magnetic coupling member may include at least one selected from the group consisting of a magnet, an electromagnet, and a permanent magnet, and when the magnetic coupling member is a magnetized member, the magnetic coupling member may include a metal or ferromagnetic substance that can be coupled to the magnetic member using magnetism.

The contact terminal may be configured as one of a planar terminal, of which an end has a planar or concave surface, and an elastic terminal, of which an end has elasticity of a spring provided inside the elastic terminal or only the end bends toward a printed circuit board (PCB) with elasticity, and the planar terminal may have a structure in which the planar terminal is recessed into an inner side of a through hole formed in the contact surface JS or corresponds to a plane of the through hole, and the elastic terminal may have a structure in which a part of the elastic terminal protrudes toward an outer side of the through hole formed in the contact surface.

The guide may be formed as one of an embossed guide that protrudes from the contact surface and an intagliated guide that is recessed into the contact surface.

When the magnetic coupling member is a magnet, the magnetic coupling member may be manufactured using at least one method selected from the group consisting of vertical monopole, two-pole and four-pole magnetizers using equipment called a ‘magnetizing yoke’.

### DESCRIPTION OF THE DRAWINGS

FIG. 1 is a perspective view of a universal serial bus (USB) memory having a non-insertion type connector according to an exemplary embodiment of the present invention and a gender connected to the USB memory.

FIG. 2 is a side cross-sectional view of the USB memory having the non-insertion type connector and the gender connected to the USB memory illustrated in FIG. 1.

FIG. 3 is a view of a non-insertion type connector and a non-insertion type port of the USB memory and the gender of FIG. 1.

FIG. 4 is a view of contact terminals disposed on a printed circuit board (PCB) in the non-insertion type connector and the non-insertion type port of FIG. 3.

### MODE OF THE INVENTION

Hereinafter, the present invention will be described in detail by explaining exemplary embodiments of the invention with reference to the attached drawings.

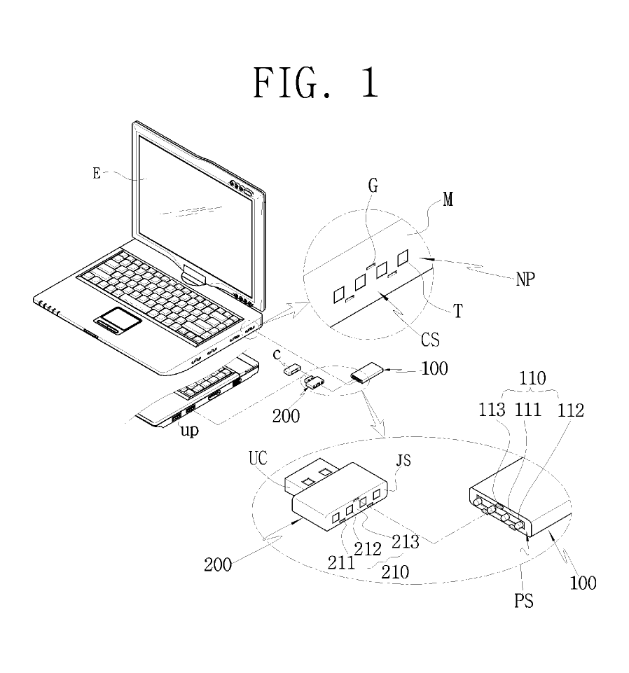

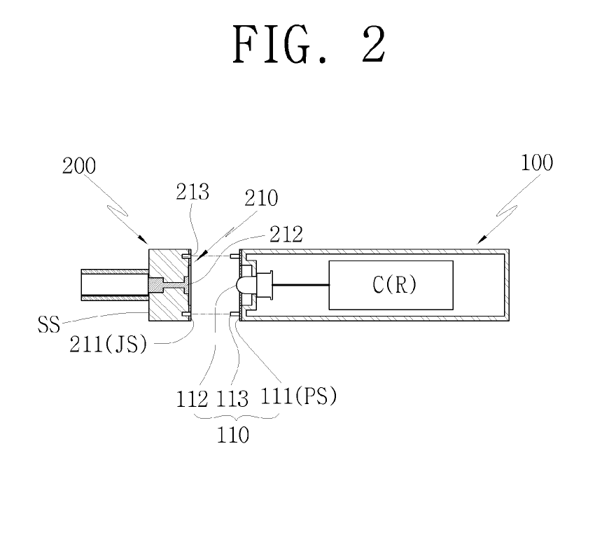

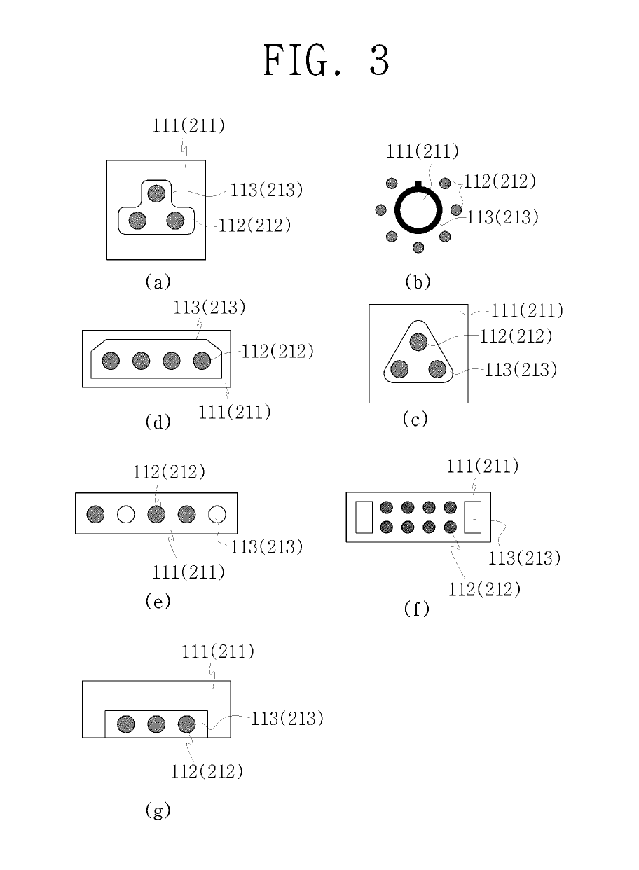

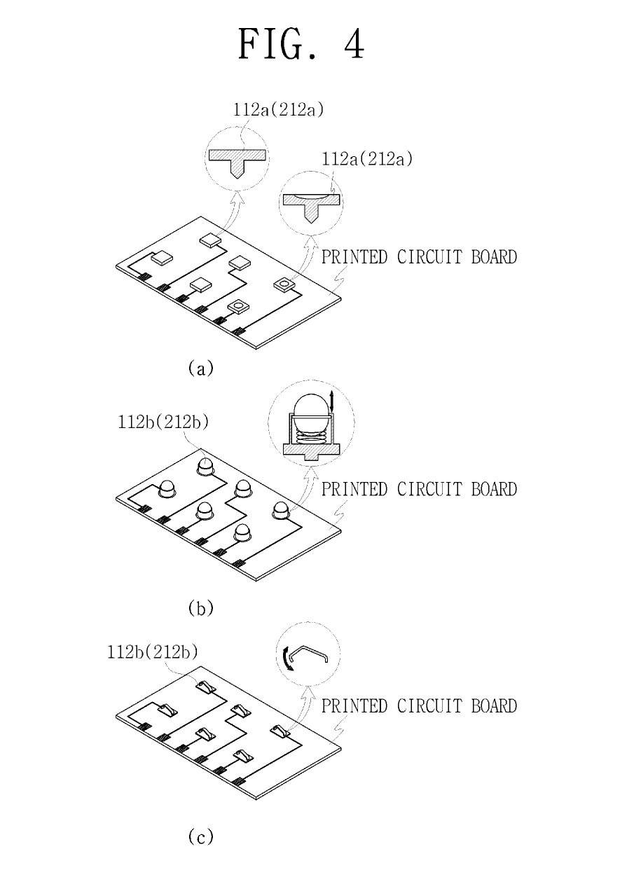

FIG. 1 is a perspective view of a universal serial bus (USB) memory having a non-insertion type connector according to an exemplary embodiment of the present invention and a gender connected to the USB memory, and FIG. 2 is a side cross-sectional view of the USB memory having the non-insertion type connector and the gender connected to the USB memory illustrated in FIG. 1. FIG. 3 is a view of a non-insertion type connector and a non-insertion type port of the USB memory and the gender of FIG. 1, and FIG. 4 is a view of contact terminals disposed on a printed circuit board (PCB) in the non-insertion type connector and the non-insertion type port of FIG. 3.

As illustrated in FIGS. 1 through 4, a USB memory 100 according to an exemplary embodiment of the present invention includes a non-insertion type connector 110 that provides an interface that comes into non-insertion contact with a non-insertion type port NP of an electronic device E, such as a personal computer (PC), using magnetism and that enables data transmission/reception with the electronic device E, a memory R in which data received from the electronic device E are stored, and a control unit C that controls the USB memory 100 to store the received data of the electronic device E through the non-insertion type connector 110 in the memory R or to read the data that are previously stored in the memory R and to transmit the data to the electronic device E through the non-insertion type connector 110.

Here, in the USB memory 100, controlling data transmission/reception using the control unit C is a well-known technology. Thus, a detailed description thereof will be omitted, and a configuration of electrical connection between the non-insertion type connector 110 of the USB memory 100 and the non-insertion type port NP of the electronic device E using magnetism will be described in detail.

That is, in the USB memory 100 according to an exemplary embodiment of the present invention, the non-insertion type connector 110 that is connected to the non-insertion type port NP of the electronic device E using magnetism, is a connector that is configured at a contact surface PS of a body and comes into surface contact with the non-insertion type port NP of the electronic device E using magnetism. The non-insertion type connector 110 includes a magnetic coupling member 111 that is formed on the contact surface PS of the body and comes into surface contact with a magnetic coupling member M formed on a contact surface CS of the non-insertion type port NP using magnetism, a contact terminal 112 that is formed on the contact surface PS and comes into non-insertion contract with a contact terminal T of the non-insertion type port NP when the magnetic coupling members 111 and M are coupled to each other using magnetism, thereby enabling reciprocal power supply and data transmission, and a guide 113 that is formed on the contact surface PS and causes a guide G of the non-insertion type port NP to be guided so that non-insertion contact of the contact terminals 112 and T can be precisely performed when the magnetic coupling members 111 and M are coupled to each other using magnetism.

On the other hand, the non-insertion type port NP of the electronic device E connected to the non-insertion type connector 110 of the USB memory 100 according to the present invention is a port that comes into surface contact with the non-insertion type connector 110 using magnetism. The non-insertion type port NP of the electronic device E includes the magnetic coupling member M that is formed on the contact surface CS of the electronic device E and is coupled to the magnetic coupling member 111 using magnetism, the contact terminal T that is formed on the contact surface CS and comes into non-insertion contact with the contact terminal 112 when the magnetic coupling members 111 and M are coupled to each other using magnetism, thereby enabling reciprocal power supply and data transmission, and the guide G that is formed on the contact surface CS and is guided by the guide 113 so that non-insertion contact of the contact terminals 112 and T can be precisely performed when the magnetic coupling members 111 and M are coupled to each other using magnetism.

The magnetic coupling member 111 is a coupling member that is formed on the contact surface PS of the body and comes into surface contact with and is coupled to the magnetic coupling member M formed on the contact surface CS of the non-insertion type port NP using magnetism. The magnetic coupling member 111 may be placed on the contact surface PS of the body to have various shapes and areas. For example, the magnetic coupling member 111 may be provided to have an area corresponding to an area of the contact surface PS other than the contact terminal 112 and the guide 113, may be provided at one side of the contact terminal 112 and the guide 113 to have the area, or may be integrally formed with the guide 113.

Here, the magnetic coupling members 111 and M may be configured as one of a magnetic member and a magnetized member. When the magnetic coupling members 111 and M are magnetic members, the magnetic coupling members 111 and M may be at least one selected from the group consisting of a magnet, an electromagnet, a permanent magnet, a monopole magnetizer, and a multi-pole magnetizer. When the magnetic coupling members 111 and M are magnetized members, the magnetic coupling members 111 and M may include metals or ferromagnetic substances that may be coupled to the magnetic members using magnetism.

Thus, when the magnetic coupling member M of the non-insertion type port NP of the electronic device E is a magnetic member, the magnetic coupling member 111 may be a magnetic member having attraction with respect to the magnetic member or a magnetized member so that the magnetic coupling members 111 and M can be coupled to each other using magnetism. When the magnetic coupling member M is a magnetized member, the magnetic coupling member 111 may be a magnetic member so that the magnetic coupling members 111 and M can be coupled to each other using magnetism.

Meanwhile, when the magnetic coupling members 111 and M are magnets, the magnetic coupling members 111 and M are manufactured as vertical monopole, two-pole and four-pole magnetizers using equipment called a ‘magnetizing yoke’ without physically dividing the magnets so as to have various numbers of polarities, or a metal substance may be placed at at least one selected from a rear side, right and left sides, and upper and lower sides of each of the magnets so that magnetism can be improved using securing linearity of magnetism, or when the magnets are coupled to each other using magnetism, only corresponding polarities of the magnets are coupled so that, when the non-insertion type connector 110 and the non-insertion type port NP need to come into contact with each other with directivity, contact in a reverse direction can also be prevented. Thus, according to the magnetic coupling member 111 of the non-insertion type connector 110, when the contact surface PS of the body comes into surface contact with the contact surface CS of the non-insertion type port NP, the magnetic coupling member M can be coupled to the magnetic coupling member 111 using magnetism.

The contact terminal 112 may be integrally formed on a PCB provided at an inner side of the contact surface PS using a plating method or mounted on the PCB using a shape of a pin.

Here, the contact terminal 112 having various numbers may be disposed on the contact surface PS of the body. Also, the contact terminal 112 may include a planar terminal 112a, of which an end has a planar or concave surface, and an elastic terminal 112b, of which an end rebounds and is inserted into the PCB with elasticity of a spring provided inside the elastic terminal 112b or only the end bends toward the PCB with elasticity. The planar terminal 112a has a structure in which the planar terminal 112a is recessed into an inner side of a through hole formed in the contact surface PS or corresponds to a plane of the through hole, and the elastic terminal 112b has a structure in which a part of the elastic terminal 112b protrudes toward an outer side of the through hole formed in the contact surface PS.

Thus, when the contact terminal 212 of the non-insertion type port NP of the electronic device E is a planar terminal 212a, the contact terminal 112 may include the elastic terminal 112b that enables reciprocal electrical contact with the contact terminal 212. When the contact terminal 212 is an elastic terminal 212b, the contact terminal 112 may be the planar terminal 112a that enables reciprocal electrical contact with the contact terminal 212.

Thus, according to the contact terminal 112 of the non-insertion type connector 110, the contact surface CS of the non-insertion type port NP elastically comes into contact with the contact surface PS of the body when the magnetic coupling members 111 and M for surface contact are coupled to each other using magnetism, thereby enabling power supply and data transmission between the non-insertion type connector 110 and the non-insertion type port NP.

Meanwhile, the contact terminal 112 may be formed on the PCB using various methods including assembling a material to which an electric current may be applied, i.e., the pin or an iron piece that is processed by etching and pressing, as well as the contact terminal 112 being integrally formed when a plating procedure for manufacturing the PCB is performed.

The guide 113 is a guide member that guides the guide G of the non-insertion type port NP so that, when the non-insertion type port NP comes into surface contact with the contact surface PS, the guide 113 can be formed on the contact surface PS and non-insertion contact between the contact terminals 112 and T can be precisely performed as intended when the magnetic coupling members 111 and M are coupled to each other using magnetism. The guide 113 may be placed on the contact surface PS of the body to have various shapes and areas. For example, the guide 113 may be formed to cover a plurality of contact terminals 112 with one group, or to include the magnetic coupling member 111 in a position of the contact surface PS, or one or a plurality of contact terminals 112 may be independently performed in the position of the contact surface PS.

Here, the guide 113 may be formed as one of an embossed guide that protrudes from the contact surface PS and an intagliated guide that is recessed into the contact surface PS. When the guide G of the non-insertion type port NP of the electronic device E is an embossed guide, the guide 113 may be formed as an intagliated guide so that reciprocal insertion and combination can be performed. When the guide G of the non-insertion type port NP is an intagliated guide, the guide 113 may be formed as an embossed guide so that reciprocal insertion and combination can be performed. Thus, when the non-insertion type connector 110 and the non-insertion type port NP need to come into contact with each other with directivity, contact in a reverse direction can also be prevented.

Thus, the guide 113 of the non-insertion type connector 110 is guided by the guide G of the non-insertion type port NP so that, when the non-insertion type port NP comes into surface contact with the contact surface PS, non-insertion contact between the contact terminals 112 and T can be precisely performed as intended when the magnetic coupling members 111 and M are coupled to each other using magnetism. Thus, the non-insertion type port NP can be prevented from being unintentionally separated from a contact portion and simultaneously, the contact terminals 112 and T can be prevented from coming into contact with each other in the reverse direction according to shapes.

Meanwhile, the guide 113 may also be formed on the contact surface PS to correspond to the exterior of a case C on the contact surface CS of the non-insertion type port NP. Thus, the contact surface CS of the non-insertion type port NP may be precisely placed on the contact surface PS of the non-insertion type connector 110.

Thus, according to the USB memory 100, the USB memory 100 is guided toward the non-insertion type port NP of the electronic device E, comes into surface contact with the non-insertion type port NP using magnetism and simultaneously, the contact terminals 112 and T come into non-insertion contact with each other. Thus, the USB memory 100 can be easily connected to or separated from the non-insertion type port NP, and unstable connection of terminals and damage of components that are conventional problems can be prevented.

Meanwhile, a gender 200 connected to the non-insertion type connector 110 of the USB memory 100 according to the exemplary embodiment of the present invention is a conversion member that causes the USB memory 100 having the non-insertion type connector 110 to be connected to the electronic device E having a general USB port UP (not the non-insertion type port NP described above). The gender 200 includes a non-insertion type port 210 that is formed at one side of the body and comes into non-insertion contact with the non-insertion type connector 110 using magnetism and a USB connector UC that is formed at the other side of the body and is inserted into the USB port UP of the electronic device E.

Here, the non-insertion type port 210 is a port that comes into surface contact with the non-insertion type connector 110 using magnetism. The non-insertion type port 210 includes a magnetic coupling member 211 that is formed on a contact surface JS of a body and is coupled to the magnetic coupling member 111 of the non-insertion type connector 110, a contact terminal 212 that is formed on the contact surface JS and comes into non-insertion contact with the contact terminal 112 when the magnetic coupling members 211 and 111 are coupled to each other using magnetism, thereby enabling reciprocal power supply and data transmission, and a guide 213 that is formed on the contact surface JS and is guided by the guide 113 so that non-insertion contact of the contact terminals 212 and 112 can be precisely performed when the magnetic coupling members 211 and 111 are coupled to each other using magnetism. Preferably, the non-insertion type port 210 have a configuration that is the same as or similar to that of the non-insertion type port NP of the electronic device E and thus, a detailed description thereof will be omitted.

The USB connector UC is inserted into the USB port UP of the electronic device E in a state in which the USB connector UC is electrically connected to the non-insertion type port 210. The USB connector UC has a well-known configuration and thus, a detailed description thereof will be omitted.

Thus, the magnetic coupling member 211, the contact terminal 212 and the guide 213 of the non-insertion type port 210 are configured so that reciprocal opposed configurations with the magnetic coupling member 111, the contact terminal 112 and the guide 113 of the non-insertion type connector 110, i.e., a magnetic member and a magnetized member, a planar terminal and an elastic terminal, and an embossed guide and an intagliated guide may correspond to each one configuration. Thus, the non-insertion type port 210 and the non-insertion type connector 110 may face each other and may be coupled to each other so that power supply and data transmission between the electronic device E and the USB memory 100 can be performed.

In this case, the magnetic coupling members 211 and 111 may be provided at both or either of the non-insertion type port 210 and the non-insertion type connector 110.

Also, the body of the gender 200 may be configured so that the contact surface JS fully accommodates and surrounds the contact surface PS of the USB memory 100. The body of the gender 200 may be connected to the body of the USB memory 100 via a loss prevention unit, such as a loop, so as to prevent losses.

Meanwhile, in the present invention, when the non-insertion type connector 110 comes into surface contact with the non-insertion type port 210, contact surfaces are guided by each of the guides 113 and 213. However, it is obvious to one of ordinary skill in the art that the above-described function can be performed through embossing and intaglio operations of the magnetic coupling members 211 and 111. Thus, a detailed description thereof will be omitted.

Also, a protection cover C may be selectively attached to the contact surface PS of the non-insertion type connector 110 and the contact surface JS of the gender 200 so as to protect the connectors (the non-insertion type connector 110 and the USB connector UC) and simultaneously to prevent magnetism of the magnetic coupling members 211 and 111 from leaking to the outside.

Thus, according to the gender 200 connected to the non-insertion type connector 110 of the USB memory 100, the USB connector UC is connected to the general USB port UP of the electronic device E in a state in which the non-insertion type connector 110 is connected to the non-insertion type port 210 using magnetism, so that reciprocal data transmission/reception can be performed.

Thus, according to the present invention described above, a non-insertion type connector is configured at a USB memory so that the non-insertion type connector can come into non-insertion contact with a non-insertion type port of an electronic device, such as a PC.

Furthermore, by using a gender in which a non-insertion type port is configured at one end of the gender so as to come into non-insertion contact with the non-insertion type connector using magnetism and a USB connector is configured at the other end of the gender so as to be inserted into a USB port of the electronic device, the USB memory having the non-insertion type connector can be electrically connected to the electronic device having the general USB port.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a non-insertion type connector is configured at a USB memory so that the non-insertion type connector can come into non-insertion contact with a non-insertion type port of an electronic device, such as a PC.

Furthermore, by using a gender in which a non-insertion type port is configured at one end of the gender so as to come into non-insertion contact with the non-insertion type connector using magnetism and a USB connector is configured at the other end of the gender so as to be inserted into a USB port of the electronic device, the USB memory having the non-insertion type connector can be electrically connected to the electronic device having the general USB port.

1. A universal serial bus (USB) memory comprising a non-insertion type connector (110) that comes into non-insertion contact with a non-insertion type port (NP) of an electronic device (E) using magnetism and enables data transmission/reception with the electronic device (E),
wherein the non-insertion type connector (110) comprises:
a magnetic coupling member (111) that is formed on a contact surface (PS) of a body and comes into surface contact with a magnetic coupling member (M) formed on a contact surface (CS) of the non-insertion type port (NP) using magnetism; and
a contact terminal (112) that is formed on the contact surface (PS) and comes into non-insertion contact with the contact terminal (T) of the non-insertion type port (NP) when the magnetic coupling members (111) and M are coupled to each other using magnetism, thereby enabling reciprocal power supply and data transmission.

2. The USB memory of claim 1, wherein the non-insertion type connector (110) further comprises a guide (113) that is formed on the contact surface (PS) and causes a guide (G) of the non-insertion type port (NP) to be guided so that non-insertion contact of the contact terminals (112) and (T) can be precisely performed when the magnetic coupling members (111) and M are coupled to each other using magnetism.

3. The USB memory of claim 1, wherein the magnetic coupling member (111) is configured as one of a magnetic member and a magnetized member, and when the magnetic coupling member (111) is a magnetic member, the magnetic coupling member (111) comprises at least one selected from the group consisting of a magnet, an electromagnet, and a permanent magnet, and when the magnetic coupling member (111) is a magnetized member, the magnetic coupling member (111) comprises a metal or ferromagnetic substance that is capable of being coupled to the magnetic member using magnetism.

4. The USB memory of claim 1, wherein the contact terminal (112) is configured as one of a planar terminal (112a), of which an end has a planar or concave surface, and an elastic terminal (112b), of which an end has elasticity of a spring provided inside the elastic terminal (112b) or only the end bends toward a printed circuit board (PCB) with elasticity, and
the planar terminal (112a) has a structure in which the planar terminal (112a) is recessed into an inner side of a through hole formed in the contact surface (PS) or corresponds to a plane of the through hole, and
the elastic terminal (112b) has a structure in which a part of the elastic terminal (112b) protrudes toward an outer side of the through hole formed in the contact surface (PS).

5. The USB memory of claim 2, wherein the guide (113) is formed as one of an embossed guide that protrudes from the contact surface (PS) and an intagliated guide that is recessed into the contact surface (PS).

6. The USB memory of claim 3, wherein, when the magnetic coupling member (111) is a magnet, the magnetic coupling member (111) is manufactured using at least one method selected from the group consisting of vertical monopole, two-pole and four-pole magnetizers using equipment called a ‘magnetizing yoke’.

7. A gender in a universal serial bus (USB) memory (100) having a non-insertion type connector (110) that is formed on a contact surface (PS) and comprises a magnetic coupling member (111) and a contact terminal (112), the gender comprising:
a non-insertion type port (210) that is formed at one side of a body and comes into electrical non-insertion contact with the non-insertion type connector (110) using magnetism; and
a USB connector (UC) that is formed at the other side of the body and is inserted into a USB port (UP) of the electronic device (E),
wherein the non-insertion type port (210) comprises:
a magnetic coupling member (211) that is coupled to the magnetic coupling member (111) using magnetism; and
a contact terminal (212) that comes into non-insertion contact with the contact terminal (112) when the magnetic coupling members (211) and (111) are coupled to each other using magnetism.

8. The gender of claim 7, wherein, when the non-insertion type connector (110) comprises a guide (113) formed on the contact surface (PS), the non-insertion type connector (210) further comprises a guide (213) that is formed on the contact surface (JS) and is guided by the guide (113) so that non-insertion contact of the contact terminals (212) and (112) can be precisely performed when the magnetic coupling members (211) and (111) are coupled to each other using magnetism.

9. The gender of claim 7, wherein the magnetic coupling member (211) is configured as one of a magnetic member and a magnetized member, and when the magnetic coupling member (211) is a magnetic member, the magnetic coupling member (211) comprises at least one selected from the group consisting of a magnet, an electromagnet, and a permanent magnet, and when the magnetic coupling member (211) is a magnetized member, the magnetic coupling member (211) comprises a metal or ferromagnetic substance that is capable of being coupled to the magnetic member using magnetism.

10. The gender of claim 7, wherein the contact terminal (212) is configured as one of a planar terminal, of which an end has a planar or concave surface, and an elastic terminal, of which an end has elasticity of a spring provided inside the elastic terminal or only the end bends toward a printed circuit board (PCB) with elasticity, and
the planar terminal has a structure in which the planar terminal is recessed into an inner side of a through hole formed in the contact surface (JS) or corresponds to a plane of the through hole, and
the elastic terminal has a structure in which a part of the elastic terminal protrudes toward an outer side of the through hole formed in the contact surface (JS).

11. The gender of claim 8, wherein the guide (213) is formed as one of an embossed guide that protrudes from the contact surface (JS) and an intagliated guide that is recessed into the contact surface (JS).

12. The gender of claim 9, when the magnetic coupling member (211) is a magnet, the magnetic coupling member (211) is manufactured using at least one method selected from the group consisting of vertical monopole, two-pole and four-pole magnetizers using equipment called a ‘magnetizing yoke’.
